(19) United States
(12) Patent Application Publication
(10) Pub. No.: US 2024/0375980 A1
(43) Pub. Date: Nov. 14, 2024

(54) METHODS AND SYSTEMS FOR TREATING WASTE BY MIXING HIGH AND LOW PH WASTE STREAMS

(71) Applicant: Strathcona Resources Ltd., Calgary (CA)

(72) Inventor: Keith M. BUREAU, Bonnyville (CA)

(21) Appl. No.: 18/657,637

(22) Filed: May 7, 2024

Related U.S. Application Data
(60) Provisional application No. 63/500,859, filed on May 8, 2023.

(51) Int. Cl. C02F 1/66; C02F 101/10

(52) U.S. Cl. CPC C02F 1/66; C02F 2101/101; C02F 2209/06

(57) ABSTRACT

New methods and systems for treating waste streams produced by thermal oil production processes, such as Steam-Assisted Gravity Drainage (SAGD) are disclosed. One or more high pH waste streams are combined with one or more low pH waste streams to produce a waste stream with a more neutral pH and/or to sequester one or more hazardous components within such waste streams.

### CROSS-REFERENCE TO RELATED APPLICATIONS

The present application claims priority from U.S. Provisional Application No. 63/500,859 filed on May 8, 2023, the contents of which are incorporated herein by reference in their entirety.

### TECHNICAL FIELD

This invention relates generally to systems and methods for treating hazardous waste streams associated with thermal oil production processes, and lowering the operating cost of such processes as a result.

### BACKGROUND

Various thermal oil production processes may be used in the extraction of heavy crude oil, or bitumen, from underground oil sands deposits. Some examples of thermal oil processes include Steam-Assisted Gravity Drainage (SAGD) and Cyclic Steam Stimulation (CSS).

In a traditional SAGD process, an upper horizontal well, often known as a steam injection well, and lower horizontal well, often known as a production well, are drilled beneath the surface-generally around four to ten metres apart. High-temperature steam is injected into the reservoir through the upper horizontal well. The lower well collects crude oil or bitumen which flows downward because of the effects of gravity and recovered water from condensation of the injected steam. Typically, bitumen is so viscous that it will not flow unless it is heated or diluted with other hydrocarbons. The heat from the steam reduces the viscosity of the bitumen or heavy crude oil. With lower viscosity, the heavy crude oil or bitumen is able to flow down the reservoir to the lower horizontal well for collection. The bitumen can be combined with water in the lower horizontal well, and then pumped to the surface in this less viscous state, where the water and bitumen are separated.

According to some estimates, for each barrel of oil produced, approximately 2 to 4 barrels of water may be required. With recycling, this number of barrels of water can be reduced. As water availability becomes more limited, water availability and usage can become a limiting factor, and so options for treating this water so that it can be reused become increasingly important.

Thermal oil production processes such as SAGD and CSS produce various waste streams. Some such waste streams are derived from gas separation or vapour recovery and tend to contain hazardous gases. In some cases, these are acidic gases such as, for example, hydrogen sulfide (H2S). These low pH waste streams can be hazardous to handle, and must be disposed of using specialized techniques. In many cases, these acid gases are ultimately disposed of by flaring, or burning, which can lead to adverse environmental consequences. Therefore, in addition to limitations associated with the handling of hazardous materials generally, there may also be various regulatory limitations involved in handling or disposing of such materials, such as from regulatory air discharge permits.

Other waste streams from thermal oil production include streams originating from use of recycled water for steam generation, as described, for example, with respect to the SAGD process. Such streams typically have a very high pH and may include evaporator/concentrator blowdown and steam generator blowdown. These liquid waste streams may demand premium pricing for disposal, processing and/or handling due to their extremely high pH.

There are also known safety risks associated with transporting both high pH and low pH materials, including components of waste streams from thermal oil production. For example, it is known that H2S can become unstable in liquids where the H2S concentration is too high or the pH is too low. If the H2S were to return to the gas phase during transport or disposal it could present an extreme safety hazard.

It is recognized that it may be desirable to develop improved methods and systems for sequestering these hazardous components, for reducing the cost associated with the disposal of same, and for lessening safety risks associated with the transport thereof.

### SUMMARY OF THE INVENTION

The present invention describes methods and processes for mixing low pH and high pH waste streams produced in thermal oil production processes such as SAGD and CSS. While the invention is described herein largely in relation to SAGD, it will be appreciated that this invention may be useful in other applications (including, without limitation, CSS) where high and low pH waste streams are present. The present invention describes methods for mixing two or more liquid waste streams, two or more gas waste streams, or one or more gas waste streams with one or more liquid waste streams. The present invention also describes a control system that controls waste streams being mixed in the proper proportion to make a final mixture that is in a stable form for safe transport. Such control system may include sensors for pH and/or H2S, which could be used to control the mixing process to assure the waste streams were mixed in the right proportion and the final waste stream met any requirements for transport such as certain pH ranges.

The method of the invention involves mixing high pH and low pH waste streams to produce a final waste stream that meets the advantages of sequestering hazardous acid gases to prevent them being flared and/or producing a final liquid waste stream of moderate pH that could be transported and disposed of safely at lower cost than the high pH liquid waste stream associated with conventional SAGD or CSS processes.

In one broad aspect of the invention, there is provided a method for treating waste streams produced in a thermal oil production process, comprising reacting a first waste stream produced in the thermal oil production process having a high pH with a second waste stream produced in the thermal oil production process having a low pH, wherein the resultant product has a pH value that is between the high pH of the first waste stream and the low pH of the second waste stream.

In another aspect, there is provided the method for treating waste streams of the invention, wherein the first waste stream comprises steam generator blowdown.

In another aspect, there is provided the method for treating waste streams of the invention, wherein the first waste stream comprises evaporator blowdown.

In another aspect, there is provided the method for treating waste streams of the invention, wherein the second waste stream comprises gas containing hydrogen sulfilde.

In another aspect, there is provided the method for treating waste streams of the invention, wherein the first waste stream is comprised of more than one high pH components.

In another aspect, there is provided the method for treating waste streams of the invention, wherein the second waste stream is comprised of more than one low pH components.

In another aspect, there is provided the method for treating waste streams of the invention, wherein the first waste stream is a gas waste stream.

In another aspect, there is provided the method for treating waste streams of the invention, wherein the first waste stream is a liquid waste stream.

In another aspect, there is provided the method for treating waste streams of the invention, wherein the second waste stream is a gas waste stream.

In another aspect, there is provided the method for treating waste streams of the invention, wherein the second waste stream is a liquid waste stream.

In another aspect, there is provided the method for treating waste streams of the invention, wherein the pH of the first waste stream is greater than 7.0 and below 9.0.

In another aspect, there is provided the method for treating waste streams of the invention, wherein the pH of the first waste stream is greater than or equal to 9.0, and less than 11.0.

In another aspect, there is provided the method for treating waste streams of the invention, wherein the pH of the first stream is greater than or equal to 11.0 and less than or equal to 14.0.

In another aspect, there is provided the method for treating waste streams of the invention, wherein the pH of the second stream is greater than or equal to 0.0 and less than 3.0.

In another aspect, there is provided the method for treating waste streams of the invention, wherein the pH of the second stream is greater than or equal to 3.0 and less than 5.0.

In another broad aspect of the invention, there is provided a method for treating waste streams produced in a thermal oil production process, comprising reacting a first waste stream produced in the thermal oil production process having a high pH with a second waste stream produced in the thermal oil production process having a low pH, wherein the resultant product has as acidic component sequestered therein.

In another aspect, there is provided the method for treating waste streams of the invention wherein the resultant product has as acidic component sequestered therein, wherein the first waste stream comprises steam generator blowdown.

In another aspect, there is provided the method for treating waste streams of the invention wherein the resultant product has as acidic component sequestered therein, wherein the first waste stream comprises evaporator blowdown.

In another aspect, there is provided the method for treating waste streams of the invention wherein the resultant product has as acidic component sequestered therein, wherein the second waste stream comprises gas containing hydrogen sulfilde.

In another aspect, there is provided the method for treating waste streams of the invention wherein the resultant product has as acidic component sequestered therein, wherein the acidic component is hydrogen sulfilde.

In another aspect, there is provided the method for treating waste streams of the invention wherein the resultant product has as acidic component sequestered therein, wherein the first waste stream is comprised of more than one high pH components.

In another aspect, there is provided the method for treating waste streams of the invention wherein the resultant product has as acidic component sequestered therein, wherein the second waste stream is comprised of more than one low pH components.

In another aspect, there is provided the method for treating waste streams of the invention wherein the resultant product has as acidic component sequestered therein, wherein the first waste stream is a gas waste stream.

In another aspect, there is provided the method for treating waste streams of the invention wherein the resultant product has as acidic component sequestered therein, wherein the first waste stream is a liquid waste stream.

In another aspect, there is provided the method for treating waste streams of the invention wherein the resultant product has as acidic component sequestered therein, wherein the second waste stream is a gas waste stream.

In another aspect, there is provided the method for treating waste streams of the invention wherein the resultant product has as acidic component sequestered therein, wherein the second waste stream is a liquid waste stream.

In another aspect, there is provided the method for treating waste streams of the invention wherein the resultant product has as acidic component sequestered therein, wherein the pH of the first waste stream is greater than 7.0 and below 9.0.

In another aspect, there is provided the method for treating waste streams of the invention wherein the resultant product has as acidic component sequestered therein, wherein the pH of the first waste stream is greater than or equal to 9.0, and less than 11.0.

In another aspect, there is provided the method for treating waste streams of the invention wherein the resultant product has as acidic component sequestered therein, wherein the pH of the first stream is greater than or equal to 11.0 and less than or equal to 14.0.

In another aspect, there is provided the method for treating waste streams of the invention wherein the resultant product has as acidic component sequestered therein, wherein the pH of the second stream is greater than or equal to 0.0 and less than 3.0.

In another aspect, there is provided the method for treating waste streams of the invention wherein the resultant product has as acidic component sequestered therein, wherein the pH of the second stream is greater than or equal to 3.0 and less than 5.0.

### BRIEF DESCRIPTION OF THE DRAWINGS

Embodiments will now be described by way of example only with reference to the appended drawings wherein:

FIG. 1 is a schematic diagram showing the method and process of the invention.

### DETAILED DESCRIPTION OF THE INVENTION

Provided herein is a method and system for improving disposal of waste from thermal oil production processes, such as SAGD or CSS, by mixing waste streams having high pH and low pH components produced in the oil production process to produce a waste stream having a pH which is closer to neutral. Also provided herein is a method and system for improving disposal of waste from thermal oil production processes, such as SAGD or CSS, by mixing waste streams having high pH and low pH components produced in the oil production process to produce a waste stream in which H2S is sequestered into a high pH waste stream. It will be appreciated that, in some cases, mixing one or more components having high pH with one or more components having low pH will result in a mixed product having a pH closer to a neutral pH.

The in-situ process of SAGD and CSS generates H2S through the produced water and oil that is recovered from the reservoir. The unique and challenging part of the in-situ process is that the initial H2S concentration (by mol fraction of total produced gas) does not stay consistent. There is a condition during the life of the recovery process (aquathermolysis) that occurs that causes the concentration to rise. The challenge then comes when thermal operation burns all of its produced gas in the boilers. The H2S portion of the gas is converted into sulphur dioxide (SO₂) when burned in the fired equipment on site. SO₂ is an emission that may need to be monitored and managed as per the regulatory approvals and licenses given by the various regulatory bodies. The need to scrub SO₂ from flu gas that is produced by boilers due to regulatory limitations is required.

As H2S that is in the produced gas from wells climbs in volume, this can cause convergence on the regulatory limits that have been put in place for the thermal facilities. One possible solution to address climbing H2S is sequestering H2S in the produced gas into a high pH fluid. This potential solution arose when evaluating H2S evolution from produced water into the steam phase as possible concern. Therefore, any dissolved H2S in the inlet feed stream should get converted to a bisulphite ion once the pH gets elevated to 11. The bisulphite then stays in the water phase and is ultimately cycled out of the process.

The idea of utilizing the high pH (˜12 pH) waste fluid that is generated from evaporators on site to sequester H2S was developed. This leads to the concept of flowing H2S rich produced gas through a contactor tower to sequester the H2S with the evaporator waste that is 12.5 pH. At this point, produced gas stream can be “sweetened” by utilizing evaporator waste that is generated at site. The waste can be hauled off site and disposed down a cavern with a higher bisulphite content and perhaps a minor down grading of the pH.

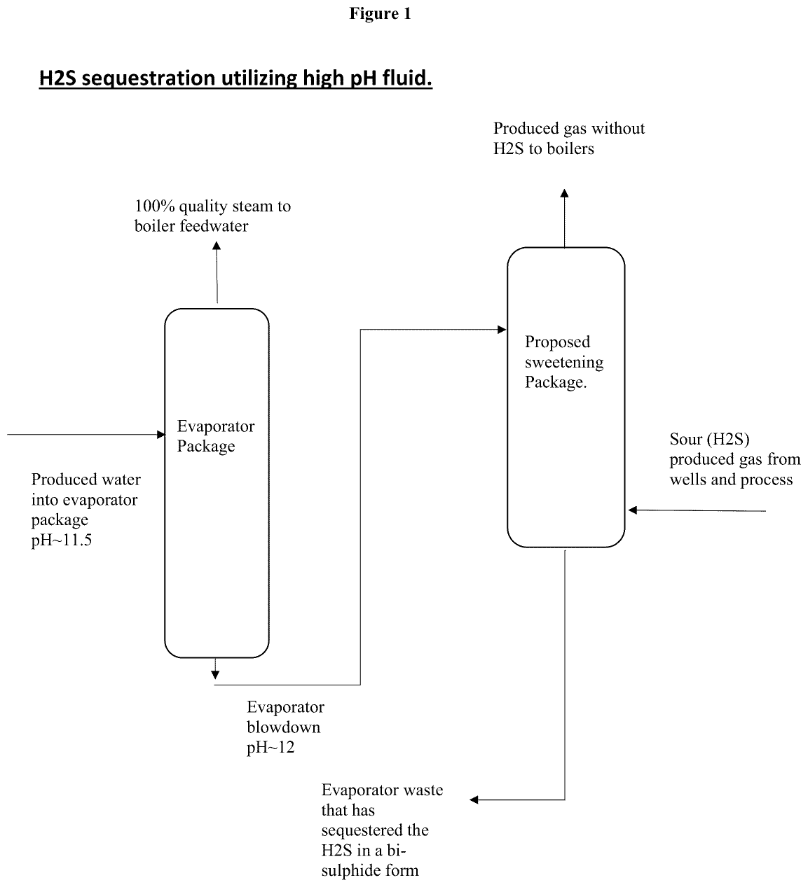

FIG. 1 is a schematic diagram showing the method and process of the invention. As shown in the diagram, produced water having a pH of around 11.5 is introduced into an evaporator. The evaporator converts the produced water into steam, and high pH evaporator blowdown (ph˜12) is produced as a high pH waste stream. That high pH waste stream is contacted with sour produced gas from the wells and thermal oil production process, which gas contains H2S, and has a low pH. This produces gas without H2S that can be supplied to the boilers of the thermal oil production process, and an evaporator waste stream that has sequestered the H2S in a bi-sulphide form.

In one embodiment, high pH liquid waste may be derived from recycling water produced with the oil for the generation of steam used in the SAGD process. This may include steam generator blowdown or evaporator/concentrator blowdown, for example. Although some examples of high pH streams are provided herein, it will be appreciated that the method of the invention could apply to other high pH streams as well.

One or more low pH streams might be contacted with the high pH waste with the goal of sequestering hazardous acid gases from the low pH stream and producing a final stable liquid waste stream at a moderate pH.

The low pH stream could be a gas or a liquid or a combination of gas and liquid. In a typical SAGD process, for example, two large volume gas streams that might be used are the field gas separated from the produced oil and the combustion gas from the steam generators. Several gas or gas/liquid streams may be generated from venting various processes like evaporator deaerators or from collecting vapor off of the various tanks in the system. Although some examples of low pH streams are provided herein, it will be appreciated that the method of the invention could apply to other low pH streams as well.

In an embodiment of the invention, low pH streams and high pH streams produced in association with the same thermal oil production process are contacted with one another to produce a resultant product having a more moderate pH than the waste streams which were contacted with one another. The low pH stream could be contacted with the high pH stream in a variety of ways. For example, a contactor may be used to put the various low pH and high pH streams into contact with one another. The chemical driving force for the neutralization between the low pH stream and the high pH stream may be high and the kinetics of the neutralization may be governed by the design aspects of the contactor.

The low pH stream could be contacted with the high pH stream in a simple liquid/liquid mixing chamber or various types of gas/liquid contactors that might employ, for example, bubbling column designs or spray contactors.

It will be appreciated that it may be important to control the flow rates of both streams into the contactor so that the mixing proportion of the two streams and the rate of the mixing could be positively controlled. The contactor may be designed in such a way as to take into account the heat of the neutralization reaction and the chemical specification of the final waste stream in terms of temperature, pH and concentrations of potentially hazardous species such as H2S or sulfide ion. It will be appreciated that positive control of the chemical parameters of the final waste stream may be beneficial for producing a liquid product where the acid gases were sequestered in a stable manner. For instance, if the contact process were taken too far, the final stream could contain a concentration of H2S that was not stable at the final pH, which could lead to the release of this hazardous gas during transport or disposal of the final waste stream.

In one specific example, low pH field gas produced in a thermal oil production process could be contacted with high pH water evaporator blowdown produced from the same process. The field gas may be separated from the oil produced in the thermal oil production process, and used to fire the steam generators. Field gas is largely methane but can contain varying amounts of H2S, which can be detrimental to the environment if it is burned, which is a traditional manner of disposing of waste streams of thermal oil production containing H2S and methane. As a consequence, the amount of H2S that may be burned is generally subject to waste environmental regulation. Burning the H2S can also cause damage to the combustion equipment used to burn the H2S. It will therefore be appreciated that it may be advantageous to separate H2S from the field gas prior to burning the field gas. One way to accomplish this would be to sequester the H2S into the high pH liquid waste stream.

Chemical scrubbers currently exist for field gas where the field gas is bubbled through a tower of amine which binds the acid gases. The amine is periodically regenerated by heating and the acid gases are collected in concentrated form during the generation. It will be appreciated that a similar bubbling tower contactor could be used in the present invention.

In an embodiment of the present invention, the liquid could be the high pH evaporator blowdown waste stream. The low pH field gas could be bubbled through the high pH evaporator blowdown at a controlled rate. The acid gases could be neutralized by the high pH waste and dissolve in that liquid, thus lowering its pH. The tower could be operated in a steady state where the chemical composition of the liquid in the tower would be monitored to maintain targets for the final pH and concentration of H2S. The flow of fresh high pH evaporator blowdown into the contactor and the flow of final moderate pH liquid waste out of the contactor may be controlled to maintain the target chemical composition of the final moderate pH waste stream in terms of pH and H2S concentration. Design of the contactor may have to take into account the heat of neutralization and the materials of construction would have to resist the corrosivity of the process streams.

For simplicity and clarity of illustration, where considered appropriate, reference numerals may be repeated among the FIGURES to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method for treating waste streams produced in a thermal oil production process, comprising reacting a first waste stream produced in the thermal oil production process having a high pH with a second waste stream produced in the thermal oil production process having a low pH, wherein the resultant product has a pH value that is between the high pH of the first waste stream and the low pH of the second waste stream.

2. The method of claim 1, wherein the first waste stream comprises steam generator blowdown.

3. The method of claim 1, wherein the first waste stream comprises evaporator blowdown.

4. The method of claim 1, wherein the second waste stream comprises gas containing hydrogen sulfilde.

5. The method of claim 1, wherein the first waste stream is comprised of more than one high pH components.

6. The method of claim 1, wherein the second waste stream is comprised of more than one low pH components.

7. The method of claim 1, wherein the first waste stream is a gas waste stream.

8. The method of claim 1, wherein the first waste stream is a liquid waste stream.

9. The method of claim 1, wherein the second waste stream is a gas waste stream.

10. The method of claim 1, wherein the second waste stream is a liquid waste stream.

11. The method of claim 1, wherein the pH of the first waste stream is greater than 7.0 and below 9.0.

12. The method of claim 1, wherein the pH of the first waste stream is greater than or equal to 9.0, and less than 11.0.

13. The method of claim 1, wherein the pH of the first stream is greater than or equal to 11.0 and less than or equal to 14.0.

14. The method of claim 1, wherein the pH of the second stream is greater than or equal to 0.0 and less than 3.0.

15. The method of claim 1, wherein the pH of the second stream is greater than or equal to 3.0 and less than 5.0.

16. The method of claim 1, wherein the pH of the second stream is greater than or equal to 5.0 and less than 7.0.

17. A method for treating waste streams produced in a thermal oil production process, comprising reacting a first waste stream produced in the thermal oil production process having a high pH with a second waste stream produced in the thermal oil production process having a low pH, wherein the resultant product has as acidic component sequestered therein.

18. The method of claim 1, wherein the first waste stream comprises steam generator blowdown.

19. The method of claim 1, wherein the first waste stream comprises evaporator blowdown.

20. The method of claim 1, wherein the second waste stream comprises gas containing hydrogen sulfilde.

21. The method of claim 1, wherein the acidic component is hydrogen sulfide.

22. The method of claim 1, wherein the first waste stream is comprised of more than one high pH components.

23. The method of claim 1, wherein the second waste stream is comprised of more than one low pH components.

24. The method of claim 1, wherein the first waste stream is a gas waste stream.

25. The method of claim 1, wherein the first waste stream is a liquid waste stream.

26. The method of claim 1, wherein the second waste stream is a gas waste stream.

27. The method of claim 1, wherein the second waste stream is a liquid waste stream.

28. The method of claim 1, wherein the pH of the first waste stream is greater than 7.0 and below 9.0.

29. The method of claim 1, wherein the pH of the first waste stream is greater than or equal to 9.0, and less than 11.0.

30. The method of claim 1, wherein the pH of the first stream is greater than or equal to 11.0 and less than or equal to 14.0.

31. The method of claim 1, wherein the pH of the second stream is greater than or equal to 0.0 and less than 3.0.

32. The method of claim 1, wherein the pH of the second stream is greater than or equal to 3.0 and less than 5.0.

33. The method of claim 1, wherein the pH of the second stream is greater than or equal to 5.0 and less than 7.0.
